(19) United States
(12) Patent Application Publication
(10) Pub. No.: US 2011/0164080 A1
(43) Pub. Date: Jul. 7, 2011

(54) FLUID-JET DISPENSING DEVICE

(75) Inventors: James W. Ring, Blodgett, OR (US); Gilbert G. Smith, Corvallis, OR (US)

(73) Assignee: HEWLETT-PACKARD DEVELOPMENT COMPANY, LP., Houston, TX (US)

(21) Appl. No.: 13/119,437

(22) PCT Filed: Oct. 14, 2008
(86) PCT No.: PCT/US2008/079828

§ 371 Date: Mar. 17, 2011

(51) Int. Cl. B41J 29/38; B41J 2/135

(52) U.S. Cl. 347/9; 347/44

(57) ABSTRACT

Systems, methods, and other embodiments associated with fluid-jet dispensers are described. In one embodiment, a method (400) controls a fluid jet dispenser. The fluid jet dispenser includes a plurality of nozzles for precisely ejecting fluid and a plurality of ejection chambers. The fluid-jet dispenser includes one or more fluid channels for supplying fluid from a fluid reservoir to the plurality of ejection chambers and corresponding nozzles. The method includes detecting (405) that the fluid-jet dispenser has not ejected fluid for a predetermined time. The method applies a de-prime pressure (410). The de-prime pressure is a negative pressure to withdraw fluid from the nozzles and the ejection chambers to a high capillary force area within each of the one or more fluid channels to remove fluid from the plurality of nozzles.

### BACKGROUND

Thermal ink jet printing technology is widely used in many commercial products such as printers and facsimile machines. Typical ink jet printers include a print head that receives ink from an ink reservoir. An ink channel supplies ink from the ink reservoir to the print head. The print head includes ejection chambers with corresponding nozzles. An ejection chamber creates pressure on the ink within the ejection chamber to eject an ink bubble through a corresponding nozzle. After ejecting ink from the ejection chamber, new ink is drawn into the chamber from the ink channel. However, ink that remains within the chamber and is within the nozzles will be exposed to air. Between printing jobs when the ink does not move from the nozzles, the exposed ink at the nozzles can dry and/or clog the nozzles.

To prevent the print head nozzles from becoming clogged or having a reduced performance because of dried ink, several remedies have been used. One remedy is to cover the area of the print head containing the nozzles with a cap in between print operations. However, the cap is not completely air tight and drying of the ink may still occur over time. Another approach is to periodically eject ink through the nozzles even when not printing, to keep the nozzles clear. However, this approach requires a spittoon to catch the ejected ink and wastes ink that is not used for printing. Other techniques include manually applying a moisturizing solution to the print head or wiping the crusted or dried material off the print head to extend the life of the print head.

### SUMMARY

One embodiment includes a method for controlling a fluid-jet dispenser that includes a plurality of nozzles for precisely ejecting fluid and a plurality of ejection chambers. The fluid-jet dispenser includes one or more fluid channels for supplying fluid from a fluid reservoir to the plurality of ejection chambers and corresponding nozzles. The method includes detecting that the fluid-jet dispenser has not ejected fluid for a predetermined time. The method includes applying a de-prime pressure that is a negative pressure to withdraw fluid from the nozzles and the ejection chambers to a high capillary force area within each of the one or more fluid channels to remove fluid from the plurality of nozzles.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates one embodiment of an example system associated with a fluid jet dispensing device.

FIG. 2 illustrates one embodiment of an example partial cross-sectional view of a fluid-jet print head.

FIG. 3 illustrates one embodiment of an example cross-sectional view of an array of ejection chambers and nozzles.

FIG. 4 illustrates one embodiment of a method of operation associated with a fluid-jet dispensing device.

FIG. 5 illustrates another embodiment of an example method of operation associated with a fluid jet dispensing device.

FIG. 6 illustrates one embodiment of an example computing environment in which example systems and methods, and equivalents, may operate.

### DETAILED DESCRIPTION

Described herein are example systems, methods and other embodiments associated with de-priming a fluid jet dispensing device (e.g a print head). In one example when a print head is idle, the fluid (e.g. ink) at the nozzles can form a meniscus and be in contact with ambient air for an extended period of time. Ink in contact with air tends to become crusty or harden over time. A nozzle may become completely clogged if the ink on the nozzle is exposed to air too long without any ink being ejected.

In one example system for extending the life of a print head of an ink jet printer, the ink in the print head is at least partially de-primed when the print head has not printed for a predetermined time. De-priming a print head involves pulling ink back from the nozzle and the ejection chamber toward the ink channel. In one embodiment, the ink is removed from the nozzle and/or the ejection chamber so that air remains. The removed ink is drawn back into a narrow ink channel and towards the ink reservoir where the ink is not exposed to air. This prevents the ink from crusting or hardening within the nozzles and/or ejection chambers. De-priming the print head may be used in combination with other techniques used to extend the life of a print head.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

PCI: peripheral component interconnect.

PCIE: PCI express.

RAM: random access memory.

DRAM: dynamic RAM.

SRAM: static RAM.

ROM: read only memory.

PROM: programmable ROM.

EPROM: erasable PROM.

EEPROM: electrically erasable PROM.

WAN: wide area network.

“Computer-readable medium”, as used herein, refers to a medium that stores signals, instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a programmable logic device, a memory stick, and other media from which a computer, a processor or other electronic device can read.

“Logic”, as used herein, includes but is not limited to hardware, firmware, software instructions stored in a computer-readable medium, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, software). Logical and/or physical communication channels can be used to create an operable connection.

“Signal”, as used herein, includes but is not limited to, electrical signals, optical signals, analog signals, digital signals, data, computer instructions, processor instructions, messages, a bit, a bit stream, or other means that can be received, transmitted and/or detected.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations include physical manipulations of physical quantities. Usually, though not necessarily, the physical quantities take the form of electrical or magnetic signals capable of being stored, transferred, combined, compared, and otherwise manipulated in a logic, and so on. The physical manipulations create a concrete, tangible, useful, real-world result.

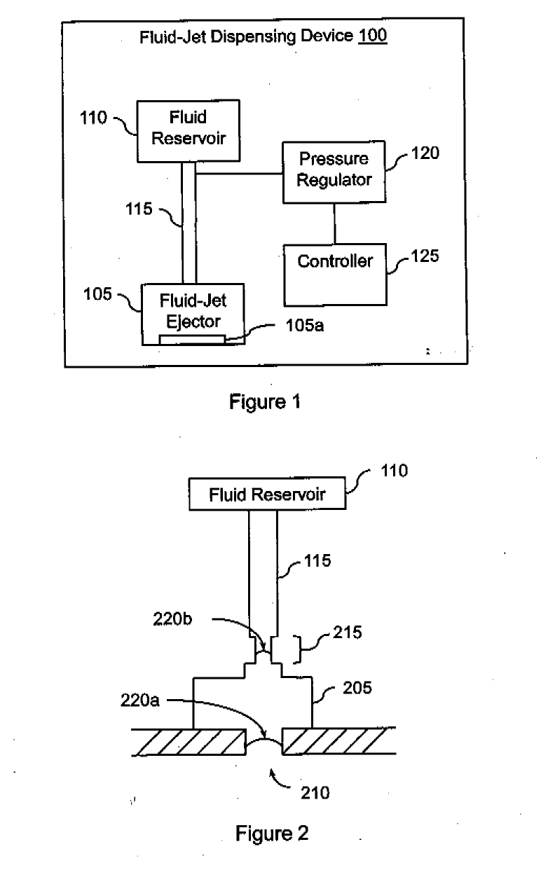

FIG. 1 illustrates one embodiment of a fluid-jet dispensing device 100 configured to de-prime a fluid jet ejector 105 (e.g. a print head 105) that includes an array of nozzles 105a. The print head 105 can be deprimed at a selected time or condition, for example, when the print head 105 has not ejected ink for a predetermined time. In one embodiment, the fluid jet dispensing device 100 will be described as a printer 100 that ejects ink, but as described herein, it also includes other types of fluid-jet dispensing devices that dispense other types of fluids. It will also be appreciated that terms like ink reservoir and ink channel, are intended to include a fluid reservoir and fluid channel, respectively. With continued reference to FIG. 1, the printer 100 also includes a fluid reservoir 110 (e.g. an ink reservoir 110) and a fluid channel 115 (e.g. an ink channel 115) in fluid communication with the print head 105 and the ink reservoir 110. The printer 100 further includes a pressure regulator 120 and a controller 125 in operable connection with the pressure regulator 120. The pressure regulator 120 is shown connected to the ink channel 115. However in other embodiments, the pressure regulator 120 may be connected with any suitable location that is in fluid communication with the ink reservoir 110, the ink channel 115, and/or the print head 105 so that the pressure regulator 120 can apply pressure to ink within the printer 100. In one embodiment, the pressure regulator 120 can include a pump and/or vacuum to create negative pressure.

As will be described further below, the pressure regulator 120 is configured to modulate a negative pressure to the ink to cause the ink to retrack or be drawn back away from the nozzles of the print head 105. The negative pressure serves to deprime the print head 105 so that any ink in the nozzles 105a will be pulled back into the print head 105. In this manner, ink does not remain in the nozzles 105a thereby reducing a possibility of the ink drying or crusting in the nozzles 105a caused by exposure to air. Since the ink is drawn back into the print head, the ink is not forced out of the nozzles as with other priming methods and thus the print head does not requiring cleaning due to leaking ink. In another embodiment, the pressure regulator 120 is further configured to modulate a pressure to re-prime the ejection chamber with ink.

In one embodiment, the example print head 105 can be implemented in high end printers or in ink printer cartridges. In high end printers, the ink reservoir 110 can be a separate and refillable reservoir. The printer 100 may include a blow prime port where the pressure regulator 120 is connected to apply the negative pressure through the blow prime port. In one embodiment, the blow prime port is formed through an ink cartridge housing to cause the print head 105 to be primed with ink. In a disposable cartridge printer system, the print head 105 and ink reservoir 110 are embodied in a replaceable ink cartridge. In the print cartridge system, the printer 100 may further comprise the controller 125 external to the cartridge where the controller 125 is configured to control the pressure regulator 120 that applies the negative pressure to the ink reservoir 110 within the cartridge.

In other embodiments, the printer 100 is more generally a fluid-jet precision-dispensing device that precisely dispenses fluid, such as ink, as is described in more detail later in the detailed description. The print head 105 may be a precision fluid ejector.

The printer 100 may eject pigment-based ink, dye-based ink, or another type of ink. Differences between pigment-based inks and dye-based inks can include that the former may be more viscous than the latter, among other differences. In these and other types of ink, the ink may be generally considered as having at least a liquid component, and may also have a solid component in the case of pigment-based inks in particular. The liquid component may be water, alcohol, and/or another type of solvent or other type of liquid, whereas the solid component may be pigment, or another type of solid.

In general, other embodiments pertain to any type of fluid-jet precision-dispensing device that dispenses a substantially liquid fluid. A fluid-jet precision-dispensing device is a drop-on-demand device in which printing, or dispensing, of the substantially liquid fluid is achieved by precisely printing or dispensing in accurately specified locations, with or without making a particular image on that which is being printed or dispensed on. As such, a fluid jet precision-dispensing device is in comparison to a continuous precision-dispensing device, in which a substantially liquid fluid is continuously dispensed therefrom. An example of a continuous precision-dispensing device is a continuous inkjet-printing device, for instance.

The fluid-jet precision-dispensing device precisely prints or dispenses a substantially liquid fluid in that the latter is not substantially or primarily composed of gases such as air. Examples of such substantially liquid fluids include inks in the case of inkjet-printing devices. Other examples of substantially liquid fluids include drugs, cellular products, organisms, fuel, and so on, which are not substantially or primarily composed of gases such as air and other types of gases, as can be appreciated by those of ordinary skill within the art. Therefore, while the following detailed description is described in relation to an inkjet-printing device that ejects ink onto media, other embodiments more generally pertain to any type of fluid-jet precision-dispensing device that dispenses a substantially liquid fluid.

FIG. 2 illustrates one embodiment of a cross section of a portion of the print head 105. The print head 105 includes an ejection chamber 205 and a nozzle 210 for ejecting ink. The ejection chamber 205 is connected to the ink channel 115. The ink channel 115 is shown in FIG. 2 as being connected to a single ejection chamber 205. However, in other embodiments, the print head 105 would include a plurality of ejection chambers 205 with corresponding nozzles 210. The ink channel 115 can be connected to an array of ejection chambers 205. In some embodiments, the ink channel 115 may fan out or split out into many smaller sub-channels associated with each ejection chamber 205 or a small group of ejection chambers 205. Each ejection chamber 205 would then be supplied with ink by a corresponding sub-channel.

In operation, the ink reservoir 110 will supply the ink channel 115 with ink. The ink will flow along the ink channel 115 to the ejection chamber 205. During a printing process, the ejection chamber 205 will eject ink through the nozzle 210. The ink may be ejected by heating the ink by a resister within the ejection chamber 205. When the ink has been heated to a high enough temperature and expanded, an ink drop is ejected from the nozzle 210. Alternatively, a mechanical system may be used within the ejection chamber 205 to eject ink through the nozzle 210. For example, applying a voltage to a piezoelectric material adjoining the ejection chamber 205 will expand that material and cause ink to be ejected from the ejection chamber 205.

When the printer 100 is not printing, the printer 100 may be partially de-primed. De-priming will extend the life of the print head 105 and can reduce the chances of the nozzle 210 and/or ejection chamber 205 from becoming clogged or coated with dried ink or other unwanted materials. De-priming involves removing ink from the nozzle 210 to reduce the exposure of the ink to air, which may cause the ink to dry out. In other embodiments, de-priming includes withdrawing ink from both the nozzle 210 and the ejection chamber 205.

In one embodiment, the ink may be drawn from the nozzle 210 and the ejection chamber 205 by creating a negative pressure on the ink within the printer 100. The controller 125 can be configured to control or signal the pressure regulator 120 to apply a negative pressure at a certain time or condition, for example, upon the printer 100 or ejection chamber 205 not ejecting ink for a predetermined time. This partially de-primes the fluid ejection device. The pressure regulator 120 will modulate a negative pressure to the ink to draw ink away from the nozzle 210 and the ejection chamber 205 and toward a high capillary force area 215. For example, FIG. 2 shows an example of an ink meniscus 220a at the nozzle 210 and then shows the meniscus 220b pulled-back to the high capillary force area 215 after applying negative pressure.

In one embodiment, the high capillary force area 215 may be within/part of the ink channel 115 upstream from the nozzle 210. Generally, the high capillary force area 215 has a higher capillary force than one or more other areas containing ink within the printer 100. In some embodiments, the high capillary force area 215 has a higher capillary force (e.g. greater force) than the nozzle 210 and has a higher capillary force than the ejection chamber 205. In other embodiments, the high capillary force area 215 is a pinch point in the ink channel 115 that is upstream from the ejection chamber 205 and the nozzle 210. For example, the pinch point has a cross sectional area less than a cross sectional area of the nozzle 210. Because the high capillary force area 215 has smaller area than the nozzle 210 and ejection chamber 205. In one embodiment, the high capillary force area 215 functions to stop air flow from depriming upstream of the high capillary force area 215.

The high capillary force area 215 is an area that creates capillary action of a liquid also known as wicking. Capillary action is the ability of a substance to draw another substance into it while replacing a third substance in the process. Capillary action occurs when the adhesive intermolecular forces between a liquid such as ink and the container holding the liquid are stronger than the cohesive intermolecular forces of the air and the container holding it. The effect causes a concave meniscus to form where the liquid substance is touching a surface. A high capillary force area 215 may be formed with a shape that creates a capillary force that prevents air from moving past the high capillary force area 215. Thus maintaining an ink channel 115 without air in it.

It may be beneficial to filter the ink before the ink reaches the ejection chamber 205. In some embodiments, the high capillary force area 215 includes a filter for filtering the ink before the ink enters the ejection chamber 205. The filter may also be placed upstream from the high capillary force area 215. The filter may include multiple filter channels where each filter channel has a smaller cross sectional area than the ink channel 115.

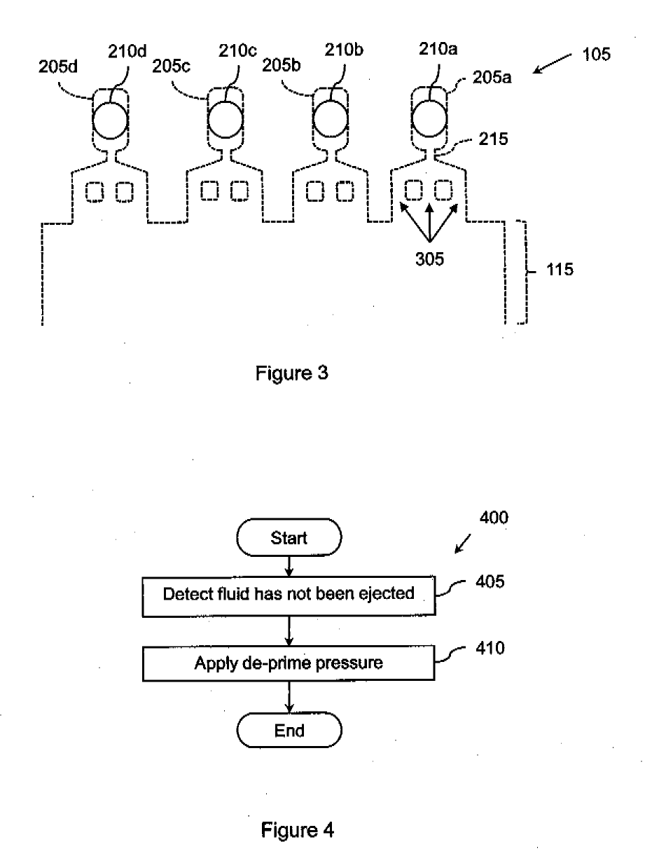

FIG. 3 illustrates a cross section of a portion of the print head 105 showing four nozzles 210a-d each with a corresponding ejection chamber 205a-d. The view in FIG. 3 is shown from the bottom looking toward the nozzles 210a-d with interior component behind the nozzles, such as the ejection chambers 205a-d, shown with dashed lines. In the view of FIG. 3, the nozzles 210a-d are oriented to eject ink perpendicularly out from the page. The ink channel 115 is shown connected to each nozzle 210a-d through three filter channels 305. The filter channels 305 are separated by two structural posts in the ink channel 115. Of course, different numbers of channels can be used. Each of the three filter channels 305 has a diameter, or cross sectional area, that is smaller than the ink channel 115.

In one embodiment, each filter channel 305 functions as the high capillary force area 215 (e.g. pinch point) shown in FIG. 2. Because each of the filter channels 305 is small, each, filter channel 305 will act as a filter for filtering particles in the ink so that larger particles do not reach the ejection chamber 205a. The ink channel 115 is shown in FIG. 3 as one large channel 115 connected to each ejection chamber 205a-d. Of course, in other example embodiments, the ink channel 115 may branch into smaller channels before reaching an ejection chamber 205a-d with the smaller channel directly connected to the corresponding ejection chamber 205a-d.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

FIG. 4 illustrates a method 400 associated with controlling a fluid jet dispenser that includes a plurality of nozzles for precisely ejecting fluid and a plurality of ejection chambers. The fluid-jet dispenser may include one or more channels for supplying fluid from a fluid reservoir to the plurality of ejection chambers and corresponding nozzles. The method 400 begins, at step 405, by detecting that the fluid-jet dispenser has not ejected fluid for a predetermined time. In some embodiments, the predetermined time may be a fixed time that has been established by the manufacture of the fluid dispenser. In other embodiments, the predetermined time may be configured by a user of the fluid dispenser. Alternatively, the predetermined time may be configured by the fluid dispenser in response to how often the fluid dispenser has been activated or how long the fluid dispenser is idle between fluid ejection operations. Inactivity of the fluid dispenser can result in a fluid meniscus that has formed a plug in the nozzles due to dry air exposure.

The method 400 continues, at 410, by applying a de-prime pressure to remove fluid from the plurality of nozzles. The de-prime pressure is a negative pressure that withdraws fluid from the nozzles back towards the fluid reservoir. In one embodiment, a sufficient negative pressure can be applied to withdraw the fluid back through the ejection chambers to a high capillary force area between the ejection chamber and the reservoir within the fluid channels. In one embodiment, a high capillary force area may be within each of the one or more fluid channels. The de-priming can extend the life of a print head by reducing the amount of time a fluid meniscus at a nozzle stays in contact with ambient air and thus reduces the possibility that the fluid dries out. In some embodiments, about negative 25-30 inches of water pressure is applied. Of course, other amounts of pressure can be used based on how much force is required for a particular fluid dispenser configuration.

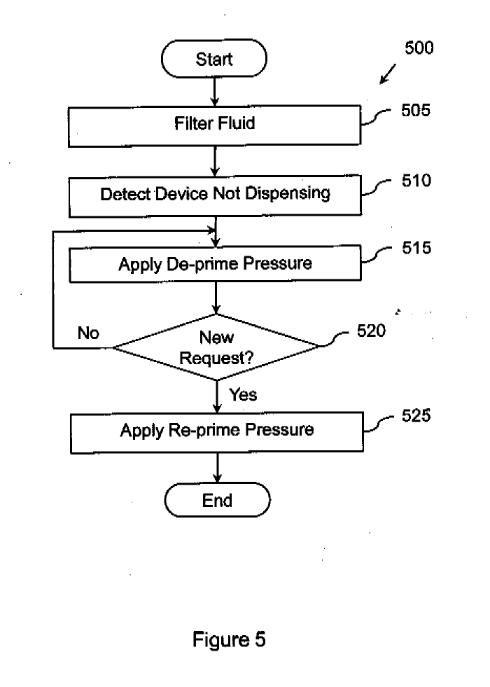

FIG. 5 illustrates another method 500 associated with dispensing fluid (e.g. printing) using a fluid-jet dispensing device (e.g. print head) having a high capillary force area. The method 500 begins, at 505, by filtering the fluid within each of the fluid channels. The filtering may be performed by any suitable technique or any method as discussed above. At 510, a detection is made that indicates the fluid jet dispensing device is not dispensing fluid or that the fluid jet dispensing device has been idle for a predetermined time. A de-prime pressure is applied, at 515, by any suitable method or as discussed above. In some embodiments, about negative 25-30 inches of water pressure is applied when applying the de-prime pressure.

At 520, a determination is made as to if a new fluid dispensing request (e.g. print request, dosage request, and so on) is pending that may require the operation of the fluid-jet dispensing device. If there is no new request, then the method 500 returns to step 515 to continue applying the de-prime pressure. If there is a new dispensing request, then, at 525, a re-prime pressure is applied. A re-prime pressure is a pressure that is a higher pressure than the de-prime pressure. For example, the re-prime pressure causes the fluid to flow back into each ejection chamber. In one embodiment, about negative 15 inches of water pressure is applied when applying the re-prime pressure. Of course, other amounts of pressure can be used based on how much pressure is required for a particular fluid jet dispensing device configuration.

In one example, a method may be implemented as computer executable instructions. Thus, one example, a computer-readable medium may store computer executable instructions that if executed by a machine (e.g., processor) cause the machine to perform a method to operate a printer that includes applying a de-prime pressure upon detecting that the printer has been idle for a predetermined time. While executable instructions associated with the above method are described as being stored on a computer-readable medium, it is to be appreciated that executable instructions associated with other example methods described herein may also be stored on a computer-readable medium.

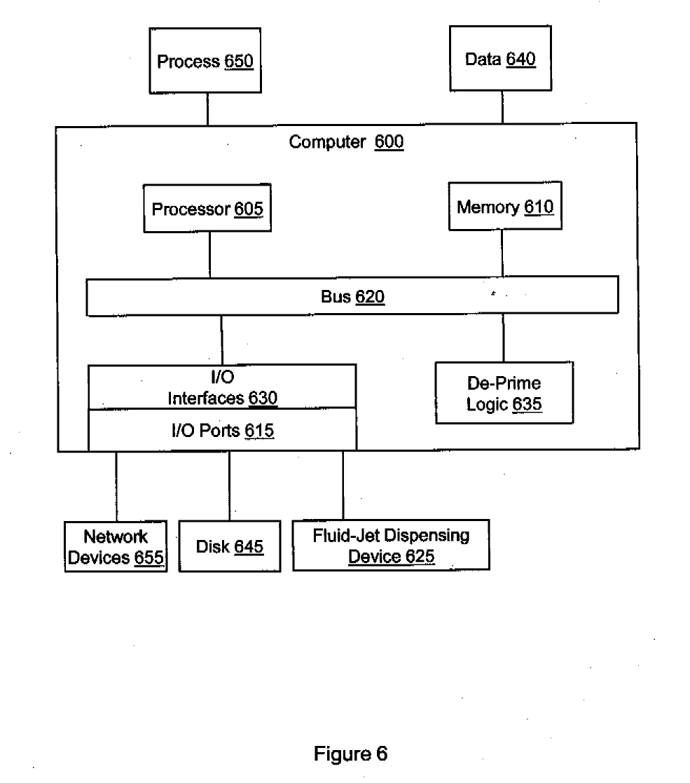

FIG. 6 illustrates an example system 600 that includes computing device in which example systems and methods described herein, and equivalents, may operate. The example computing device may be a computer 600 that includes a processor 605, a memory 610, and input/output ports 615 operably connected by a bus 620. A fluid jet dispensing device 625 may be operably connected to the computer 600 via, for example, an input/output interface (e.g., card, device) 630 and an input/output port 615. In one example, the computer 600 may include a de-prime logic 635 configured to facilitate applying a de-prime pressure upon detecting that the fluid-jet dispensing device has been idle for a predetermined time. In different examples, the de-prime logic 635 may be implemented in hardware, stored software, firmware, and/or combinations thereof. While the de-prime logic 635 is illustrated as a hardware component attached to the bus 620, it is to be appreciated that in one example, the de-prime logic 635 could be implemented in the processor 605, or in the fluid-jet dispensing device 625.

Thus, de-prime logic 635 may provide means (e.g., hardware, stored software, firmware) for operating the fluid-jet dispensing device 625. The de-prime logic is configured to apply a de-prime pressure at selected times between fluid dispensing operations. As discussed earlier, the de-prime pressure withdraws fluid from the fluid ejection nozzles and/or the ejection chambers. The de-prime pressure may be applied upon the computer 600 detecting that the fluid-jet dispensing device 625 has been idle for a predetermined time.

The means may be implemented, for example, as an ASIC programmed to configured to facilitate applying a de-prime pressure upon detecting that the fluid jet dispensing device 625 has been idle for a predetermined time. The means may also be implemented as computer executable instructions that are presented to computer 600 as data 640 that are temporarily stored in memory 610 and then executed by processor 605.

De-prime logic 635 may also provide means (e.g., hardware, software, firmware) for applying a de-prime pressure upon detecting that the fluid-jet dispensing device 625 has been idle for a predetermined time.

Generally describing an example configuration of the computer 600, the processor 605 may be a variety of various processors including dual microprocessor and other multi-processor architectures. A memory 610 may include volatile memory and/or non-volatile memory. Non-volatile memory may include, for example, ROM, PROM, and so on. Volatile memory may include, for example, RAM, SRAM, DRAM, and so on.

A disk 645 may be operably connected to the computer 600 via, for example, the input/output interface (e.g., card, device) 630 and the input/output port 610. The disk 645 may be, for example, a magnetic disk drive, a solid state disk drive, a floppy disk drive, a tape drive, a Zip drive, a flash memory card, a memory stick, and so on. Furthermore, the disk 645 may be a CD-ROM drive, a CD-R drive, a CD-RW drive, a DVD ROM, and so on. The memory 610 can store a process 650 and/or a data 640, for example. The disk 645 and/or the memory 610 can store an operating system that controls and allocates resources of the computer 600.

The bus 620 may be a single internal bus interconnect architecture and/or other bus or mesh architectures. While a single bus is illustrated, it is to be appreciated that the computer 600 may communicate with various devices, logics, and peripherals using other busses. (e.g., PCIE, 1394, USB, Ethernet). The bus 620 can be types including, for example, a memory bus, a memory controller, a peripheral bus, an external bus, a crossbar switch, and/or a local bus.

The computer 600 may interact with input/output devices via the i/o interfaces 630 and the input/output ports 615. Input/output devices may be, for example, a keyboard, a microphone, a pointing and selection device, cameras, video cards, displays, the disk 645, the network devices 655, and so on. The input/output ports 615 may include, for example, serial ports, parallel ports, and USB ports.

The computer 600 can operate in a network environment and thus may be connected to the network devices 655 via the i/o interfaces 630, and/or the i/o ports 615. Through the network devices 655, the computer 600 may interact with a network. Through the network, the computer 600 may be logically connected to remote computers. Networks with which the computer 600 may interact include, but are not limited to, a LAN, a WAN, and other networks.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this, application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Gamer, A Dictionary of Modem Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A fluid jet dispensing device, comprising:
a fluid ejector including:
an ejection chamber for containing fluid; and
a nozzle for ejecting the fluid from the ejection chamber;
a fluid reservoir to supply fluid to the fluid ejector through a fluid channel;
a high capillary force area within the fluid channel upstream from the nozzle; and
a pressure regulator to modulate a negative pressure to the fluid to draw fluid away from the nozzle and the ejection chamber to the high capillary force area to remove fluid from the nozzle.

2. The fluid-jet dispensing device of claim 1, where the high capillary force area has a higher capillary force than the nozzle and has a higher capillary force than the ejection chamber, the high capillary force area being configured to stop air flow from depriming upstream from the high capillary force area.

3. The fluid-jet dispensing device of claim 1, where the high capillary force area is a pinch point that is upstream from the ejection chamber and the nozzle and has a cross sectional area Jess than a cross sectional area of the nozzle.

4. The fluid jet dispensing device of claim 1, where the pressure regulator is further configured to modulate a pressure to re-prime the ejection chamber with fluid.

5. The fluid-jet dispensing device of claim 1, further including a controller configured to selectively modulate the pressure regulator to select the negative pressure.

6. The fluid-jet dispensing device of claim 5, where the controller is configured to cause the pressure regulator to apply the negative pressure upon the ejection chamber not ejecting fluid for a predetermined time.

7. The fluid-jet dispensing device of claim 1, where the high capillary force area, includes a filter for filtering the fluid before the fluid enters the ejection chamber.

8. The fluid jet dispensing device of claim 1, where the fluid reservoir is refillable and includes a blow prime port and the pressure regulator is connected to the blow prime port.

9. The fluid-jet dispensing device of claim 1, where the fluid ejector and fluid reservoir are embodied in a replaceable cartridge.

10. A method of controlling a fluid-jet dispenser that includes a plurality of nozzles for precisely ejecting fluid and a plurality of ejection chambers, where the fluid-jet dispenser includes one or more fluid channels for supplying fluid from a fluid reservoir to the plurality of ejection chambers and corresponding nozzles, the method comprising:
detecting that the fluid-jet dispenser has not ejected fluid for a predetermined time; and
applying a de-prime pressure that is a negative pressure to withdraw fluid from the nozzles and the ejection chambers to a high capillary force area within each of the one or more fluid channels to remove fluid from the plurality of nozzles.

11. The method of claim 10, further including:
filtering the fluid within each of the fluid channels.

12. The method of claim 10, further including:
applying a re-prime pressure that is a higher pressure than the de-prime pressure to cause the fluid to flow into each ejection chamber.

13. The method of claim 12, where about negative 15 inches of water pressure is applied when applying the re-prime pressure.

14. The method of claim 10, where about negative 30 inches of water pressure is applied when applying the de-prime pressure.

15. The method of claim 10, where the applying a de-prime pressure includes drawing a fluid meniscus in a nozzle back to the high capillary force area within each of the one or more fluid channels.

16. A fluid jet precision-dispenser, comprising:
an ejection chamber for containing fluid;
a nozzle for ejecting the fluid from the ejection chamber;
a fluid channel to supply fluid to the ejection chamber;
a high capillary force area upstream from the nozzle and being within the fluid channel; and
means for partially de-priming the fluid ejection device that withdraws fluid from the nozzle to the high capillary force area.

17. The fluid ejection device of claim 16, where the means to partially de-prime includes means for modulating a negative pressure to the fluid in the fluid ejection device; and
where the high capillary force area is formed with a greater capillary force than a capillary force in the nozzle and is greater than the capillary force in the ejection chamber.

18. The fluid ejection device of claim 16, where the means for partially de-priming includes means for drawing fluid away from the nozzle and the ejection chamber to the high capillary force area to remove fluid from the ejection chamber and the nozzle.

19. The fluid ejection device of claim 16, further including:
means for re-priming the fluid ejection device that causes fluid to flow into the ejection chamber.

20. The fluid ejection device of claim 19, where the means for re-priming includes a means for increasing the pressure on the fluid within the fluid ejection device.
